(19) United States
(12) Patent Application Publication
(10) Pub. No.: US 2018/0145880 A1
(43) Pub. Date: May 24, 2018

(54) MULTI-LAYER MANAGEMENT SYSTEM FOR SOFTWARE DEFINED NETWORK

(71) Applicant: ELECTRONICS AND TELECOMMUNICATIONS RESEARCH INSTITUTE, Daejeon (KR)

(72) Inventors: Tae Sang CHOI, Daejeon (KR); Soo Myung PARK, Daejeon (KR)

(73) Assignee: ELECTRONICS AND TELECOMMUNICATIONS RESEARCH INSTITUTE, Daejeon (KR)

(21) Appl. No.: 15/478,978

(22) Filed: Apr. 4, 2017

(30) Foreign Application Priority Data
Nov. 24, 2016 (KR) 10-2016-0157674

(51) Int. Cl. H04L 12/24; H04L 29/08

(52) U.S. Cl. CPC H04L 41/12; H04L 41/20; H04L 69/325; H04L 69/324; H04L 69/329

(57) ABSTRACT

A multi-layer management system for a software defined network (SDN) is disclosed. The multi-layer management system comprises an external relationship management functional component (ERM-FC) interworking with an external management entity and providing management functions to the external management entity, a SDN application layer management functional component (ALM-FC) for management of resources of a SDN application layer (SDN-AL); a SDN resource layer management functional component (RLM-FC) for management of resources of a SDN resource layer (SDN-RL); a SDN control layer management functional component (CLM-FC) for management of resources of a SDN control layer (SDN-CL); and a multi-layer management orchestration functional component (MMO-FC) for management of SDN application and service and inter-layer resource management.

### CLAIM FOR PRIORITY

This application claims priority to Korean Patent Application No. 2016-0157674 filed on Nov. 24, 2016 in the Korean Intellectual Property Office (KIPO), the entire contents of which are hereby incorporated by reference.

### BACKGROUND

### 1. Technical Field

The present disclosure relates to a multi-layer management system for a software-defined network (SDN), and more specifically, to a multi-layer management system for a SDN, which integrates a multi-layer management technique into the SDN, so as to control and manage physical and virtual resources of wired or wireless carrier networks.

### 2. Related Art

Various SDN controller solutions are currently available in commercial and open source formats. SDN's basic philosophy is to maximize efficiency of control by separating a control plane in a logically centralized form from an existing network where a data plane and the control plane are combined. In this case, a main role of the SDN controller is to efficiently carry out controls of the data plane for the subnetwork. However, for the efficient controls, it is necessary to organize and collaborate with configuration, performance, failure, security and billing management functions. For this purpose, existing solutions provide various methods of linking or integrating with management systems.

Most current solutions embrace some of the management functions as the main function or application of the controller, but no solution currently provides an architecture and method for tightly integrating control and management functions.

### SUMMARY

Accordingly, exemplary embodiments of the present disclosure are provided to substantially obviate one or more problems due to limitations and disadvantages of the related art.

Embodiments of the present disclosure provide a multi-layer management system for SDN, which utilizes SDN technologies and integrates all of management functions, in order to control and manage network resources and services while ensuring scalability, reliability, agility, safety and quality of network resources and services of wired and wireless carriers.

Technical objects of the present disclosure are not limited to the aforementioned technical objects and other technical objects which are not mentioned will be apparently appreciated by those skilled in the art from the following description.

In order to achieve the above-described objective, an aspect of the present disclosure provides a multi-layer management system for a software defined network (SDN). The multi-layer management system may be comprised up with an external relationship management functional component (ERM-FC) interworking with an external management entity and providing management functions to the external management entity; a SDN application layer management functional component (ALM-FC) for management of a SDN application layer (SDN-AL) resource; a SDN resource layer management functional component (RLM-FC) for management of a SDN resource layer (SDN-RL) resource; a SDN control layer management functional component (CLM-FC) for management of a SDN control layer (SDN-CL) resource; and a multi-layer management orchestration functional component (MMO-FC) for management of SDN applications and services and inter-layer resource management.

The ERM-FC may comprise an external management interworking support interface functional element for providing a management function for interworking with the external management entity; a management information abstraction functional element for processing abstraction of management information of the SDN; a request and reply interface functional element for providing a function of requesting a management operation to the external management entity and a function of replying to a request of the external management entity; an external SDN policy management functional element for providing an external SDN policy to the external management entity; and a multi-layer management orchestration support interface functional element for providing an internal interface to the MMO-FC.

The ALM-FC may comprise an application layer (AL) support interface functional element for providing an interface with the SDN-AL; an AL resource discovery functional element for performing discovery of resources of the SDN-AL; an AL resource monitoring and analytics functional element for collecting and analyzing statuses and events of the resources of the SDN-AL; and an AL resource repository functional element for storing information on the resources discovered by the AL resource discovery functional element.

The ALM-FC may further comprise an AL provisioning functional element for performing provisioning of a service of the SDN-AL; an AL fault management functional element for performing fault management of the SDN-AL; an AL performance management functional element for managing performance of the SDN-AL; an AL security management functional element for performing security management of the SDN-AL; an AL charging management functional element for performing charging management of the SDN-AL; and an AL multi-layer orchestration support interface functional element for providing an internal interface to the MMO-FC. Also, the AL fault management functional element, the AL performance management functional element, the AL security management functional element, and the AL charging management functional element may perform respective functions based on an analysis result received from the AL resource monitoring and analytics functional element.

The AL provisioning functional element may receive a service provisioning request from the SDN-AL, generate a provisioning policy, and provide the generated provisioning policy to the CLM-FC.

The RLM-FC may comprise a resource layer (RL) support interface functional element for providing an interface with the SDN-RL; a RL resource discovery and bootstrapping functional element for performing resource discovery and bootstrapping of the SDN-RL; a RL resource repository functional element for storing information on resources discovered by the RL resource discovery and bootstrapping functional element; a data and information abstraction functional element for performing abstraction of the information on resources received from the RL resource discovery and bootstrapping functional element; and a virtual and physical resource correlation analysis functional element for analyzing a correlation between a virtual resource and a physical resource based on the information on resources received from the RL resource discovery and bootstrapping functional element.

The RLM-FC may further comprise a resource layer (RL) resource monitoring and analytics functional element for analyzing resources of the SDN-RL; a RL fault management functional element for performing fault management of resources of the SDN-RL; a RL performance management functional element for performing performance management of resources of the SDN-RL; a RL security management functional element for performing security management of resources of the SDN-RL; a RL charging management functional element for performing charging management of resources of the SDN-RL; and a RL multi-layer orchestration support interface functional element for providing an interface with the MMO-FC.

The RL resource monitoring and analytics functional element may perform analysis on the resources based on the information on resources received from the RL resource discovery and bootstrapping functional element.

The RL fault management functional element, the RL performance management functional element, the RL security management functional element, and the RL charging management functional element may perform respective functions based on an analysis result received from the RL resource monitoring and analytics functional element.

The CLM-FC may comprise a control layer (CL) support interface functional element for providing an interface with the SDN-CL and the MMO-FC; a CL resource discovery functional element for performing discovery of control resources of the SDN-CL; a CL resource repository functional element for storing information on the control resources discovered by the CL resource discovery functional element; a CL resource monitoring and analytics functional element for analyzing the control resources of the SDN-CL; and a CL configuration management functional element for generating resource configuration information based on a service provisioning request received from the SDN-AL.

The CLM-FC may further comprise a control layer (CL) fault management functional element for fault management of resources of the SDN-CL; a CL performance management functional element for managing performance of the resources of the SDN-CL; a CL security management functional element for security management of resources of the SDN-CL; a CL policy management functional element for managing a policy applied to a service of the SDN-CL; and a multi-layer management orchestration support interface functional element providing an interface with the MMO-FC.

The CL fault management functional element, the CL performance management functional element, the CL security management functional element, and the CL policy management functional element may perform respective functions based on an analysis result received from the CL resource monitoring and analytics functional element.

The MMO-FC may further comprise a multi-layer orchestration support interface functional element for providing interfaces with the ALM-FC, the CLM-FC, and the RLM-FC; a RL management orchestration functional element for providing provisioning of resources of the SDN-RL and providing orchestration of configuration of the SDN-RL; a multi-layer management function orchestration functional element for supporting management of SDN application and network services; and an inter-layer service orchestration functional element for coordinating management operations between the SDN-AL, the SDN-RL, and the SDN-CL.

According to the SDN multi-layer management system based on the embodiments of the present disclosure, it is made possible to guarantee scalability, reliability, agility, safety and quality of network resources and services of wired and wireless communication service providers while utilizing SDN technology, so that more efficient network management becomes possible.

### BRIEF DESCRIPTION OF DRAWINGS

Exemplary embodiments of the present disclosure will become more apparent by describing in detail exemplary embodiments of the present disclosure with reference to the accompanying drawings, in which:

FIG. 1 is a block diagram illustrating a multi-layer management system for SDN according to an embodiment of the present disclosure;

FIG. 2 is a block diagram illustrating an application layer management functional component (ALM-FC) in a SDN multi-layer management system according to an embodiment of the present disclosure;

FIG. 3 is a block diagram illustrating a control layer management functional component (CLM-FC) in a SDN multi-layer management system according to an embodiment of the present disclosure;

FIG. 4 is a block diagram illustrating a resource layer management functional component (RLM-FC) in a SDN multi-layer management system according to an embodiment of the present disclosure;

FIG. 5 is a block diagram illustrating an external relation management functional component (ERM-FC) in a SDN multi-layer management system according to an embodiment of the present disclosure;

FIG. 6 is a block diagram illustrating a multi-layer management orchestration functional component (MMO-FC) in a SDN multi-layer management system according to an embodiment of the present disclosure;

FIG. 7 is a diagram showing a relationship between detailed functions of the functional elements in the ALM-FC among the multi-layer management function elements;

FIG. 8 is a diagram showing a relationship between detailed functions of the functional elements in the CLM-FC among the multi-layer management function elements;

FIG. 9 is a diagram showing a relationship between detailed functions of the functional elements in the RLM-FC among the multi-layer management function elements;

FIG. 10 is a sequence diagram showing information flows in the ALM-FC in a SDN multi-layer management system according to an embodiment of the present disclosure;

FIG. 11 is a sequence diagram showing information flows in the CLM-FC in a SDN multi-layer management system according to an embodiment of the present disclosure; and

FIG. 12 is a sequence diagram showing information flows in the RLM-FC in a SDN multi-layer management system according to an embodiment of the present disclosure.

### DESCRIPTION OF EXEMPLARY EMBODIMENTS

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Combinations of respective blocks in an accompanying block diagram and respective operations in a flowchart may be performed by computer program instructions. These computer program instructions can be mounted on a processor of a general purpose computer, a special purpose computer, or other programmable data processing equipment, and thus the instructions performed by the processor of the computer or other programmable data processing equipment generate a means for performing functions described in the respective blocks of the block diagram or the respective operations of the flowchart. To implement functions in a specific way, these computer program instructions can be stored in a computer-usable or computer-readable memory capable of aiming for a computer or other programmable data processing equipment, so that the instructions stored in the computer-usable or computer-readable memory can also produce a manufactured item including an instruction means for performing functions described in the respective blocks of the block diagram or the respective operations of the flowchart.

In addition, each block or operation may indicate a part of a module, a segment or a code including one or more executable instructions for executing specific logical function(s). It should be noted that mentioned functions described in blocks or operations can be executed out of order in some alternative embodiments. For example, two consecutively shown blocks or operations can be performed substantially at the same time, or can be performed in a reverse order according to the corresponding functions.

Hereinafter, a SDN multi-layer management system according to an embodiment of the present disclosure will be described in detail by referring to accompanying drawings.

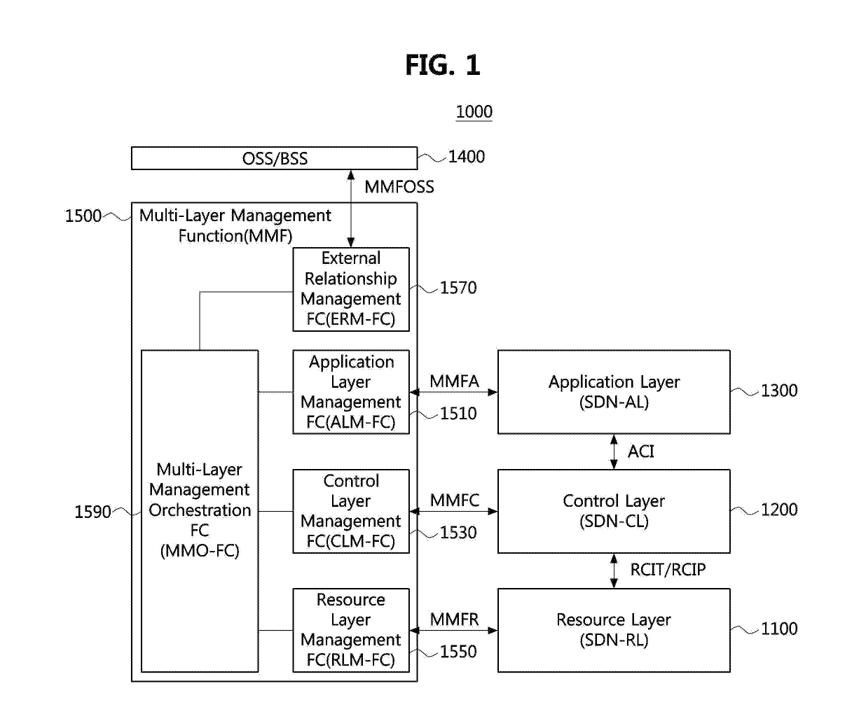

FIG. 1 is a block diagram illustrating a multi-layer management system for SDN according to an embodiment of the present disclosure.

Referring to FIG. 1, A software defined network (SDN) multi-layer management system 1000 according to an embodiment of the present disclosure may comprise five functional components, and specifically may comprise a resource layer (SDN-RL) 1100 as an SDN network infrastructure layer, an SDN control layer (SDN-CL) 1200, an SDN application layer (SDN-AL) 1300, an Operational Support System/Business Support System (OSS/BSS) 1400 which is an existing service and business management system of a wired or wireless communication service provider, and a multi-layer management function (MMF) 1500 for SDN management.

The SDN resource layer (SDN-RL) 1100 may be an SDN composed of physical and virtual network resources, and physical and virtual network resources and a network constituted by the resources may be objects of the resource layer management according to the present disclosure.

The SDN control layer (SDN-CL) 1200 may control the resources and the network in the SDN-RL 1100, and a SDN controller platform and a control resource for controlling a server to be located on the SDN-CL 1200 may be objects of the control layer management according to the present disclosure.

The SDN application layer (SDN-AL) 1300 may perform all application and service functions operating on the SDN control platform, and these application and service resources may be referred to as application layer management objects as objects of the application layer management according to the present disclosure.

The OSS/BSS 1400 may function as an existing network and service management system of a wired/wireless communication service provider for requesting functions required for management of an existing network and receiving results when cooperating for integrated management of the SDN network and existing network, and may be objects of the multi-layer management orchestration according to the present disclosure.

The multi-layer management function (MMF) 1500 may be a core function of the SDN multi-layer management system according to the present embodiment, and may be applied when coordination or cooperation between the layers or between internal components and the external management system (OSS/BSS 1400) is required.

The SDN multi-layer management function (MMF) 1500, which is a main function in the present embodiment according to the present disclosure, may include five detailed functional components, which are an SDN application layer management functional component (ALM-FC) 1510, an SDN control layer management functional component (CLM-FC) 1530, an SDN resource layer management functional component (RLM-FC) 1550, an external relationship management functional component (ERM-FC) 1570, and a multi-layer management orchestration functional component (MMO-FC) 1590.

The detailed functional components of the SDN MMF 1500 may respectively perform the following functions.

The SDN ALM-FC 1510 may perform management of resources of the SDN-AL 1300 and cross-layer orchestration driven by the SDN-AL 1300.

The SDN CLM-FC 1530 may perform management of resources used to deploy control layer functions of the SDN-CL 1200.

The SDN RLM-FC 1550 may manage physical and/or virtual resources of the SDN-RL 1100.

The ERM-FC 1570 may provide management interworking functions with the OSS/BSS 1400, which is an existing network, service, and business management system of a wired/wireless communication service provider.

The MMO-FC 1590 may perform management of SDN application and network services and multi-layer resource management.

In the embodiment shown in FIG. 1, an MMFA is an interface provided by the ALM-FC 1510 between the ALM-FC 1510 and the SDN-AL 1300, an MMFC is an interface provided by the CLM-FC 1530 between the CLM-FC 1530 and the SDN-CL 1200, and an MMFR is an interface provided by the RLM-FC 1550 between the RLM-FC 1550 and the SDN-RL 1100. Also, an MMFOSS is an interface provided by the ERM-FC 1570 between the ERM-FC 1570 and the OSS/BSS 1400.

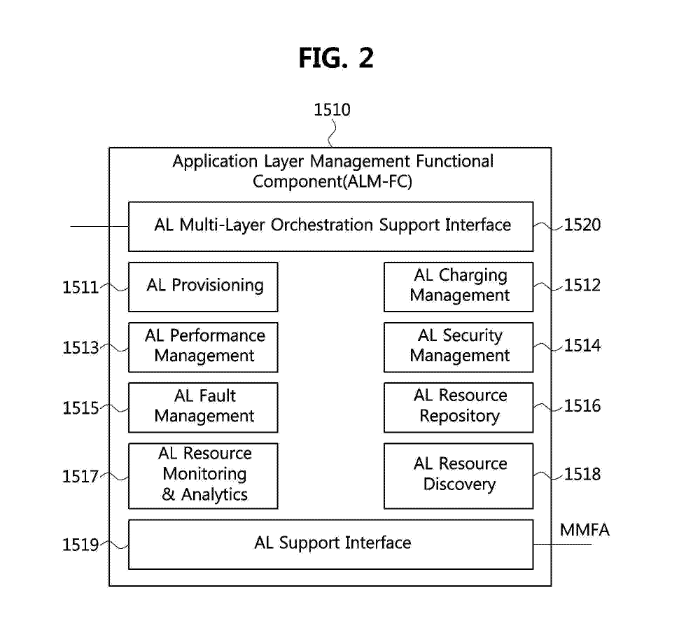

FIG. 2 is a block diagram illustrating an application layer management functional component (ALM-FC) in a SDN multi-layer management system according to an embodiment of the present disclosure.

Referring to FIG. 2, the ALM-FC 1510 of the MMF 1500 may comprise an application layer (AL) provisioning functional element 1511, an AL charging management functional element 1512, an AL performance management functional element 1513, an AL security management functional element 1514, an AL fault management functional element 1515, an AL resource repository functional element 1516, an AL resource monitoring and analytics functional element 1517, an AL resource discovery functional element 1518, an AL support functional element 1519, and an AL multi-layer orchestration support functional element 1520.

The AL provisioning functional element 1511 may perform provisioning of applications and services of the SDN-AL 1300.

The AL charging management functional element 1512 may manage accounts of the SDN-AL 1300, and measure and report usage data of the applications and services of the SDN-AL 1300.

The AL performance management functional element 1513 may monitor and manage the performance of the resources of the SDN-AL 1300.

The AL security management functional element 1514 may perform security management of the resources of the SDN-AL 1300.

The AL fault management functional element 1515 may perform fault management of the resources of the SDN-AL 1300.

The AL resource repository functional element 1516 may store information on resources of the applications and services, which are discovered by the AL resource discovery functional element 1518.

The AL resource monitoring and analytics functional element 1517 may collect and analyze resource statuses and events of the SDN-AL 1300.

The AL layer resource discovery functional element 1518 may perform discovery of applications and services resource of the SDN-AL 1300.

The AL support interface functional element 1519 may provide an interface for supporting management of the SDN-AL 1300, and an interface for requesting management operations and related information to the MMO-FC 1590 and receiving the related information from the MMO-FC 1590.

The AL multi-layer orchestration support interface functional element 1520 may provide an internal interface for requesting management operations and related information to the MMO-FC 1590 and receiving the related information from the MMO-FC 1590.

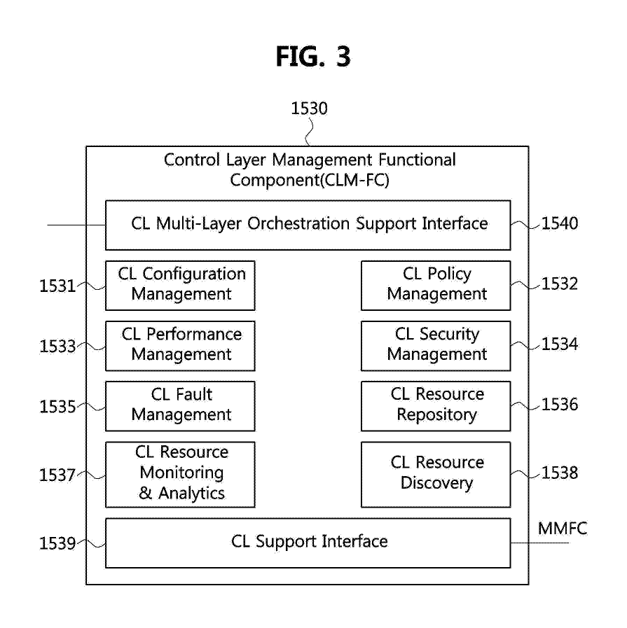

FIG. 3 is a block diagram illustrating a control layer management functional component (CLM-FC) in a SDN multi-layer management system according to an embodiment of the present disclosure.

Referring to FIG. 3, the CLM-FC 1530 may comprise a control layer (CL) configuration management functional element 1531, a CL policy management functional element 1532, a CL performance management functional element 1533, a CL security management functional element 1534, a CL fault management functional element 1535, a CL resource repository functional element 1536, a CL resource monitoring and analytics functional element 1537, a CL resource discovery functional element 1538, a CL support interface functional element 1539, and a CL multi-layer orchestration support interface functional element 1540.

The CL configuration management functional element 1531 may perform provisioning of control resources of the SDN-CL 1200 and scale the control resources based on demands and availability.

The CL policy management functional element 1532 may define, store, and retrieve policies applied to the services of the SDN-CL 1200.

The CL performance management functional element 1533 may monitor and verify the performance of resources in the SDN-CL 1200.

The CL security management function element 1534 may manage the security of the resources of the SDN-CL 1200.

The CL fault management functional element 1535 may detect a non-specific event that causes an error in the resources of the SDN-CL 1200, and generate a resolution policy by analyzing the cause.

The CL resource repository functional element 1536 may store information on the control resources discovered by the CL resource discovery functional element 1538.

The CL resource monitoring and analytics functional element 1537 may collect and analyze the statuses and events of the control resources of the SDN-CL 1200 for performance, fault, and security management.

The CL resource discovery functional element 1538 may perform discovery of the control resources in the SDN-CL 1200.

The CL support interface functional element 1539 may provide an interface to the SDN-CL 1200 and the MMO-FC 1590, in order to request management operations and related information to the SDN-CL 1200 and receive the related information from the SDN-CL 1200.

The CL multi-layer management orchestration support interface functional element 1540 may provide an interface to the MMO-FC 1590.

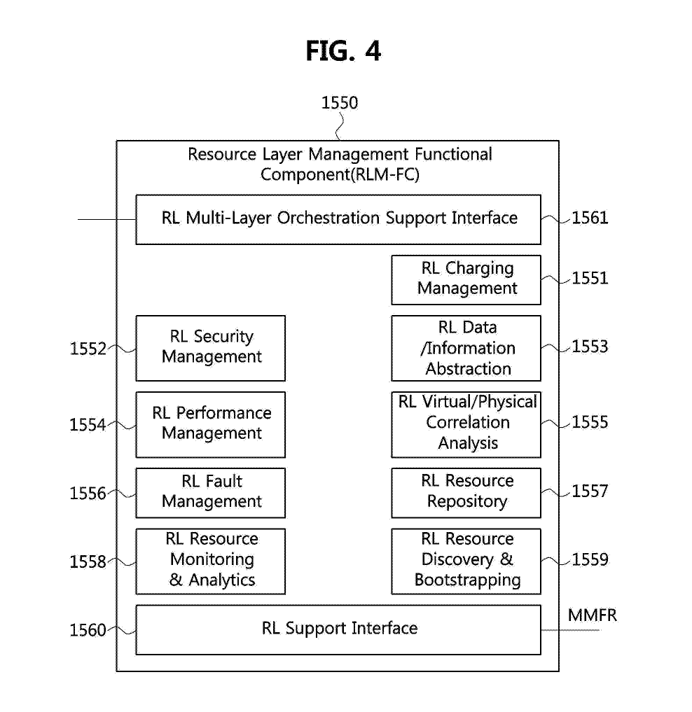

FIG. 4 is a block diagram illustrating a resource layer management functional component (RLM-FC) in a SDN multi-layer management system according to an embodiment of the present disclosure.

Referring to FIG. 4, the RLM-FC 1550 may comprise a resource layer (RL) charging management functional element 1551, a RL security management functional element 1552, a RL data/information abstraction functional element 1553, a RL performance management functional element 1554, a RL virtual/physical resource correlation analysis functional element 1555, a RL fault management functional element 1556, a RL resource repository functional element 1557, a RL resource monitoring and analytics functional element 1558, a RL resource discovery and bootstrapping functional element 1559, a RL support interface functional element 1560, and a RL multi-layer orchestration support interface functional element 1561.

The RL charging management functional element 1551 may measure and report usage data of the resources for charging.

The RL security management functional element 1552 may manage security and authentication of the SDN-RL 1100 resource and detect non-specific attacks.

The RL data/information abstraction functional element 1553 may abstract the technology-specific physical and virtual resources in the SDN-RL 110 into common information model independent of the technology.

The RL performance management functional element 1554 may monitor the performance of the physical and virtual resources of the SDN-RL 1100 and calculate an optimal energy efficient resource mapping.

The RL virtual/physical resource correlation analysis functional element 1555 may analyze the correlations between the virtual resources and the physical resources in the SDN-RL 1100.

The RL fault management functional element 1556 may perform fault management of the resources of the SDN-RL 1100.

The RL resource repository functional element 1557 may store information on the physical and virtual resources discovered by the RL resource discovery and bootstrapping functional element 1559.

The RL resource monitoring and analytics functional element 1558 may collect and analyze the statuses and events of the physical and virtual resources of the SDN-RL 1100.

The RL resource discovery and bootstrapping functional element 1559 may perform discovery and bootstrapping of physical and virtual resources in the SDN-RL 1100.

The RL support interface functional element 1560 may provide an interface for management support in the SDN-RL 1100, and an interface for requesting management operation and related information to the MMO-FC 1590 and receiving the related information from the MMO-FC 1590.

The RL multi-layer orchestration support interface functional element 1561 may provide an interface with the MMO-FC 1590.

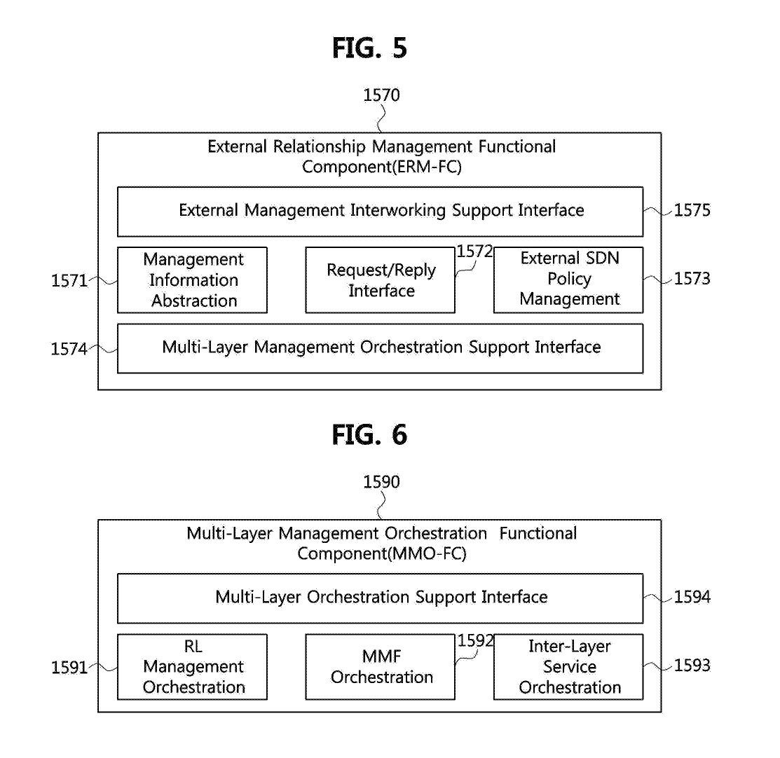

FIG. 5 is a block diagram illustrating an external relation management functional component (ERM-FC) in a SDN multi-layer management system according to an embodiment of the present disclosure.

Referring to FIG. 5, the ERM-FC 1570 may comprise a management information abstraction functional element 1571, a request/reply interface functional element 1572, an external SDN policy management functional element 1572, a multi-layer management orchestration support interface functional element 1574, and an external management interworking support interface functional element 1575.

The management information abstraction functional element 1571 may provide abstraction of SDN management information for exchanging with the external management system (OSS/BSS) 1400.

The request/reply interface functional element 1572 may provide a function of requesting and responding to the management operation with the external management system 1400.

The external SDN policy management functional element 1573 may provide the external management system with an external SDN policy.

The multi-layer management orchestration support interface functional element 1574 may provide an internal interface to the MMO-FC 1590.

The external management interworking support interface functional element 1575 may provide a management function for interworking with the external management system and play a role of a representative interface of the SDN multi-layer management system for the external management system. Also, the external management interworking support interface functional element 1575 may include a function of abstracting SDN management information for exchanging management operation requests and responses with the external management system.

FIG. 6 is a block diagram illustrating a multi-layer management orchestration functional component (MMO-FC) in a SDN multi-layer management system according to an embodiment of the present disclosure.

Referring to FIG. 6, the MMO-FC 1590 may comprise a resource layer (RL) management orchestration functional element 1591, a multi-layer management function (MMF) orchestration functional element 1592, an inter-layer service orchestration functional element 1593, and a multi-layer orchestration support interface functional element 1594.

The RL management orchestration functional element 1591 may provide resource provisioning and orchestration of configuration for the SDN-RL 1100.

The MMF orchestration functional element 1592 may support management of SDN applications and network services.

The inter-layer service orchestration functional element 1593 may coordinate management operations between the SDN-AL, SDN-CL, and SDN-RL.

The multi-layer orchestration support interface functional element 1594 may provide an interface with the ALM-FC 1510, the CLM-FC 1530, and the RLM-FC 1550.

Hereinafter, embodiments of the multi-layer management function in the SDN multi-layer management system according to an embodiment of the present disclosure will be described for each management function group.

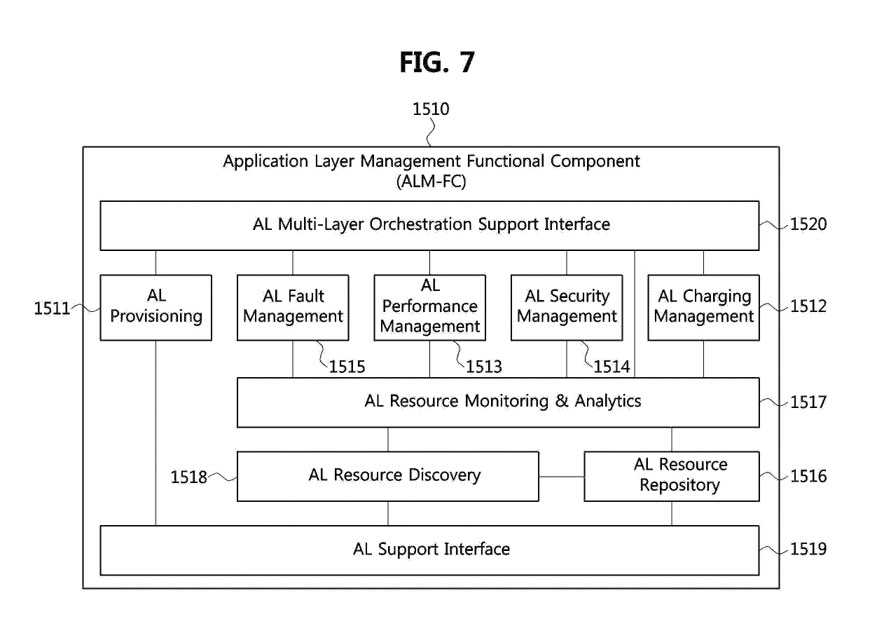

FIG. 7 is a diagram showing a relationship between detailed functions of the functional elements in the ALM-FC among the multi-layer management function elements.

Referring to FIG. 7, in order to perform the application layer management function, the AL resource discovery functional element 1518 may collect the AL management resources through the AL support interface functional element 1519, and store information on the collected AL management resources in the AL resource repository functional element 1516. At the same time, the AL resource discovery functional element 1518 may transfer the collected information to the AL resource monitoring and analytics function element 1571. The AL monitoring and analytics functional element 1571 may perform additional various purpose analysis functions on the basis of the transferred information and history information stored in the repository, and the analyzed information may be utilized in the AL charging management functional element 1512, the AL performance management functional element 1513, the AL security management functional element 1514, and the AL fault management function element 1515. Also, in response to a request of an application service, the AL provisioning functional element 1511 may perform functions needed for creating the requested application service. To this end, the request may be transmitted to the SDN-AL 1300 via the AL support interface functional element 1519. The SDN-AL 1300 may perform provisioning of the requested application service through the SDN-CL 1200 and the SDN-RL 1100.

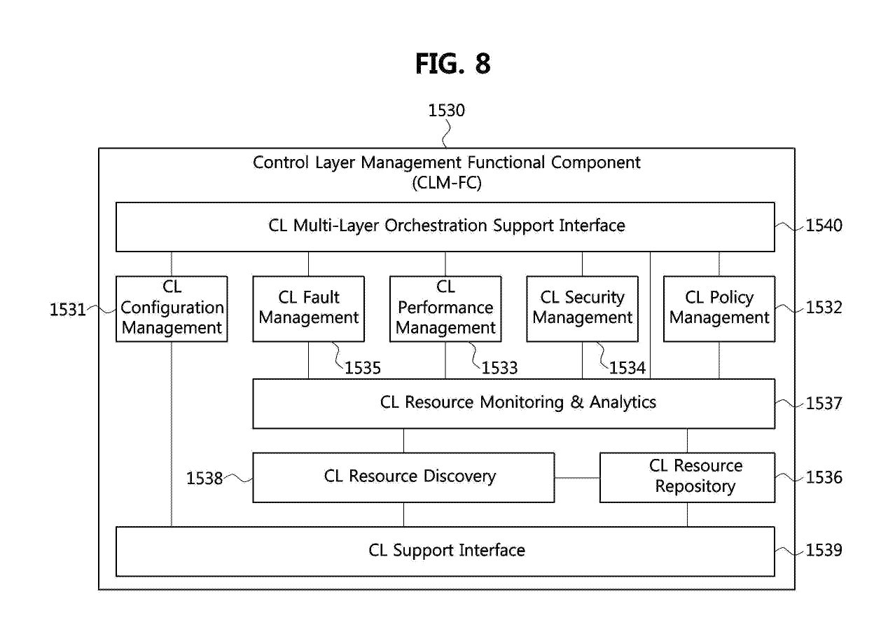

FIG. 8 is a diagram showing a relationship between detailed functions of the functional elements in the CLM-FC among the multi-layer management function elements.

Referring to FIG. 8, in order to perform the control layer management function, the CL resource discovery functional element 1538 may collect information on the CL resources through the CL support interface element 1539, and store information on the collected CL resources in the CL resource repository functional element 1536. At the same time, the CL resource discovery functional element 1538 may transfer the collected information to the CL resource monitoring and analytics function element 1537. The CL monitoring and analytics functional element 1537 may perform additional various purpose analysis functions on the basis of the transferred information and history information stored in the repository, and the analyzed information may be utilized in the CL policy management functional element 1532, the CL performance management functional element 1533, the CL security management functional element 1534, and the CL fault management functional element 1535. Also, in response to a request of a provisioning service from the SDN-AL 1300, the CL configuration management functional element 1531 may perform functions needed for creating the request service. For this, the request may be transferred to the SDN-CL 1200 through the CL support interface functional module 1539. The SDN-CL 1200 may perform configuration management functions for the provisioning through the SDN-RL.

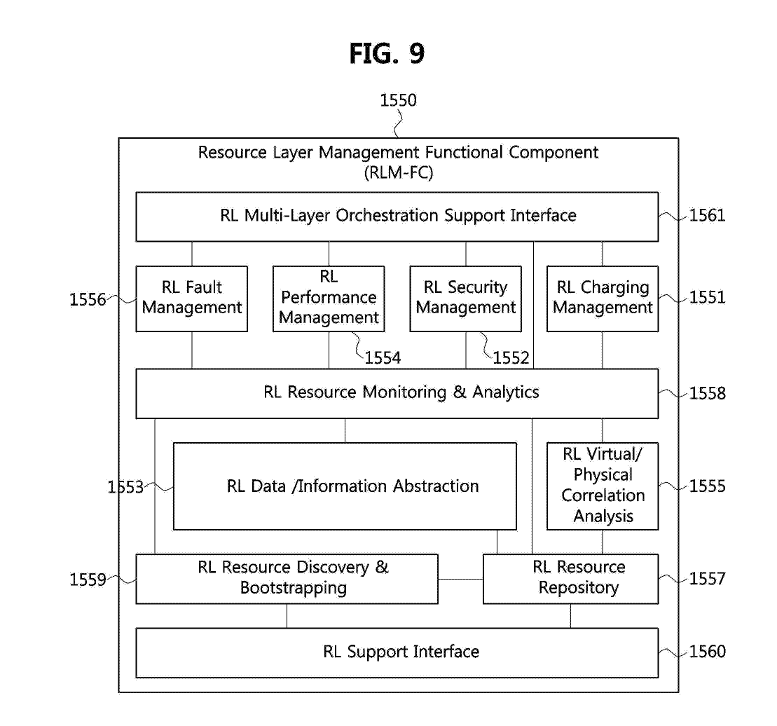

FIG. 9 is a diagram showing a relationship between detailed functions of the functional elements in the RLM-FC among the multi-layer management function elements.

Referring to FIG. 9, in order to perform the resource layer management function, the RL resource discovery and bootstrapping functional element 1559 may initialize the RL management resources through the RL support interface functional element 1560, collect information on the RL management resource, and store the collected information in the RL resource repository functional element 1557. At the same time, the RL resource discovery and bootstrapping functional element 1559 may transfer the collected information to the RL monitoring and analytics functional element 1558. The data/information abstraction functional element 1553 may abstract the collected information into a form to be used in the SDN-CL 1200 or the SDN-AL 1300, and the physical/virtual resource correlation analysis functional element 1555 may analyze the correlation between the collected physical and virtual resources and store the result in the resource repository functional element 1557.

The RL resource monitoring and analytics functional element 1558 may perform additional various purpose analysis functions on the basis of the transferred information, the abstracted information, the correlation information and history information stored in the resource repository functional element 1557, and the analyzed information may be utilized in the RL charging management functional element 1551, the RL security management functional element 1552, the RL performance management functional element 1554, and the RL fault management functional element 1556. Also, the RL resource monitoring and analytics functional element 1558 may perform necessary functions in accordance with a service request from the SDN-RL 1100. For this, the request is transferred to the SDN-RL 1100 via the RL support interface functional element 1560.

Meanwhile, the RL multi-layer orchestration support interface functional element 1561 may provide an interface with the MMO-FC 1590 to receive or request related information for a multi-layer orchestration specialized in management operations and resource layer management.

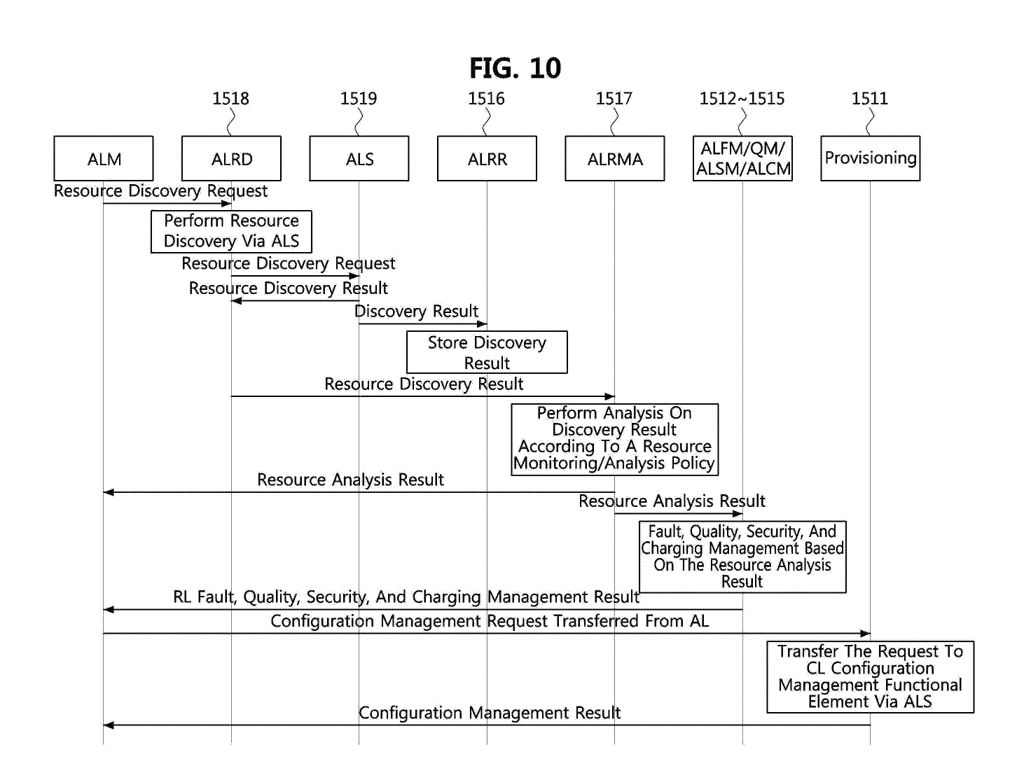

FIG. 10 is a sequence diagram showing information flows in the ALM-FC in a SDN multi-layer management system according to an embodiment of the present disclosure.

Referring to FIG. 10, an application layer manager (ALM) may request the AL resource discovery functional element (ALRD) 1518 to perform resource discovery in order to perform provisioning, fault management, quality management, security management, and charging management of the SDN-AL 1300.

The ALRD 1518 may perform an operation of discovering resources through the AL support functional element (ALS) 1519. Here, information of the discovered resources may be stored in the AL resource repository functional element (ALRR) 1516.

When the ALRD 1518 transmits the resource discovery result to the AL resource monitoring and analytics functional element (ALRMA) 1517, the ALRMA 1517 may perform necessary application resource monitoring and analysis functions, and report the result of the resource monitoring and analysis to the ALM, the AL charging management functional element (ALCM) 1512, the AL performance management functional element (QM) 1513, the AL security management functional element (ALSM) 1514 and the AL fault management functional element (ALFM) 1515.

The ALCM 1512, the QM 1513, the ALSM 1514 and the ALFM 1515 may perform respective functions based on the result of the resource monitoring and analysis.

Meanwhile, the AL provisioning functional element 1511 may receive a service provisioning request transferred from the SDN-AL 1300, generate a provisioning policy, and request the provisioning policy functional element 1531 to perform the provisioning policy. The results of the performed management are reported to the application layer manager (ALM).

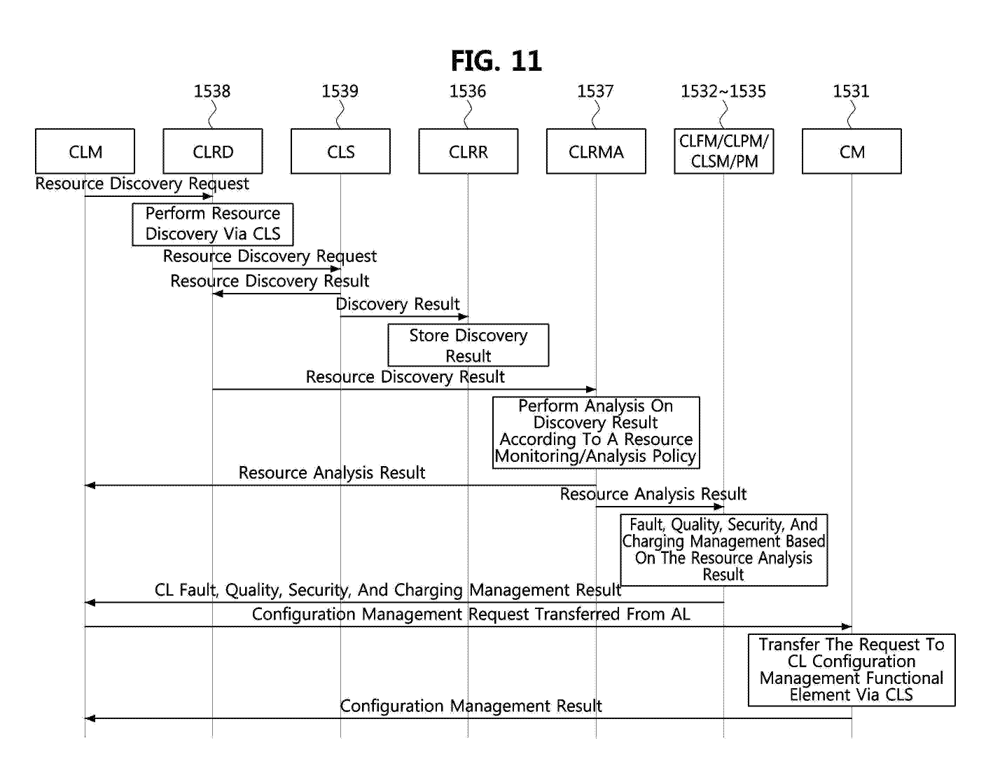

FIG. 11 is a sequence diagram showing information flows in the CLM-FC in a SDN multi-layer management system according to an embodiment of the present disclosure.

Referring to FIG. 11, a control layer manager (CLM) may request the CL resource discovery functional element (CLRD) 1538 to perform resource discovery in order to perform provisioning, fault management, performance management, security management, and policy management of the SDN-CL 1200.

The CLRD 1538 may perform an operation of discovering resources through the CL support functional element (CLS) 1539. Here, information of the discovered resources may be stored in the CL resource repository functional element (CLRR) 1536.

When the CLRD 1538 transmits the resource discovery result to the CL resource monitoring and analytics functional element (CLRMA) 1537, the CLRMA 1537 may perform necessary control resource monitoring and analysis functions, and report the result of the resource monitoring and analysis to the CLM, the CL policy management functional element (CLPM) 1532, the CL performance management functional element (PM) 1533, the CL security management functional element (CLSM) 1534 and the CL fault management functional element (CLFM) 1535.

The CLPM 1532, the PM 1533, the CLSM 1534 and the CLFM 1535 may perform respective functions based on the result of the resource monitoring and analysis.

Meanwhile, the CL configuration management functional element (CM) 1531 may receive a service provisioning request transferred from the SDN-AL 1300, generate configuration information for configuring functions of the requested resources (including physical and virtual resources), and configure the corresponding resources in the SDN-RL 1100 through control functions. The results of the performed management are reported to the control layer manager (CLM).

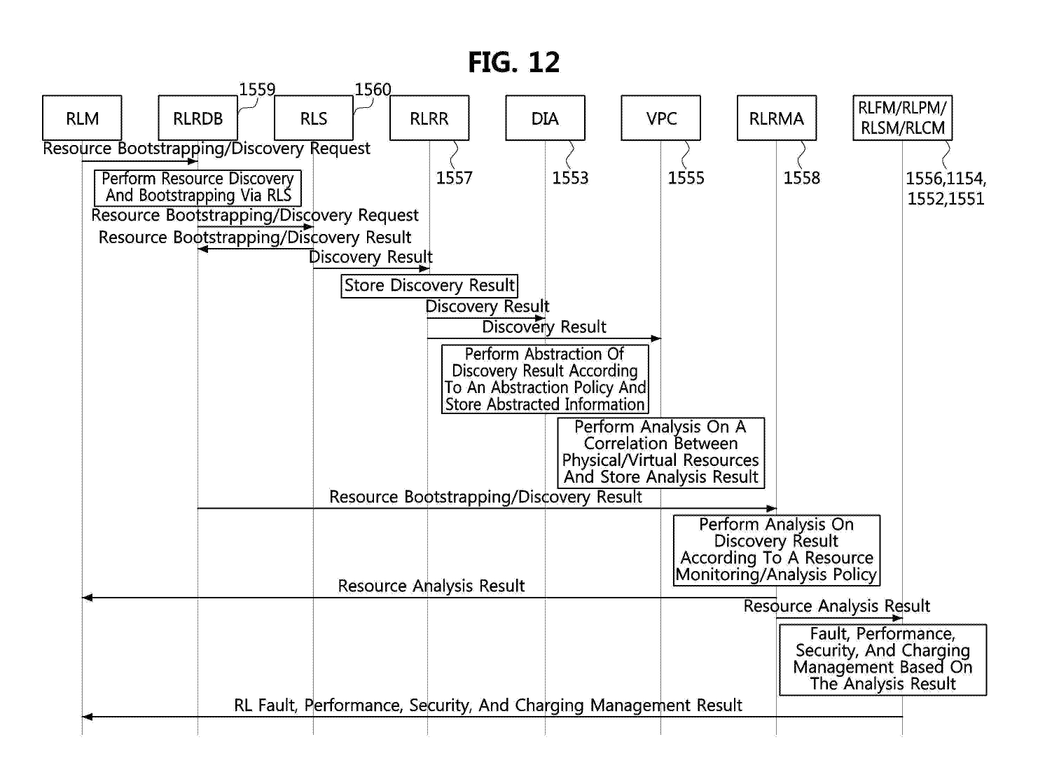

FIG. 12 is a sequence diagram showing information flows in the RLM-FC in a SDN multi-layer management system according to an embodiment of the present disclosure.

Referring to FIG. 12, a resource layer manager (RLM) may request the RL resource discovery and bootstrapping functional element (RLRDB) 1559 to perform resource bootstrapping and discovery in order to perform fault management, performance management, security management, and charging management of the SDN-RL 1100.

The RLRDB 1559 may perform an operation of initializing (bootstrapping) and discovering resources through the RL support interface functional element (RLS) 1560. Here, information of the discovered resources may be stored in the RL resource repository functional element (RLRR) 1557.

The result of discovery may be abstracted according to an abstraction policy by the data/information abstraction functional element (DIA) 1553 and then stored in the RL resource repository functional element (RLRR) 1557. In addition, the result of discovery may be stored in the RL resource repository functional element (RLRR) 1557 after the correlation analysis between the physical resources and the virtual resources is performed by the virtual/physical resource correlation analysis functional element (VPC) 1555.

After the result of discovery is notified to the RL resource monitoring and analytics functional element (RLRMA) 1558, the RLRMA 1558 may perform a resource monitoring and analysis function, and report the result of the resource monitoring and analysis to the RL charging management functional element (RLCM) 1551, the RL security management functional element (RLSM) 1552, the RL performance management functional element (RLPM) 1554, and the RL fault management functional element (RLFM) 1556.

The RLCM 1551, the RLSM 1552, the RLPM 1554, and the RLFM 1556 may perform respective functions based on the reported result. The results of the performed management are reported to the resource layer manager (RLM).

The methods according to the present disclosure can be implemented as computer readable codes in computer readable record media. Computer readable record media include all types of record media in which computer readable data is stored. Examples of computer readable record media include a ROM, a RAM, a CD-ROM, a magnetic tape, a floppy disk, and optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multi-layer management system for a software defined network (SDN), the multi-layer management system comprising:
an external relationship management functional component (ERM-FC) interworking with an external management entity and providing management functions to the external management entity;
a SDN application layer management functional component (ALM-FC) for management of resources of a SDN application layer (SDN-AL);
a SDN resource layer management functional component (RLM-FC) for management of resources of a SDN resource layer (SDN-RL);
a SDN control layer management functional component (CLM-FC) for management of resources of a SDN control layer (SDN-CL); and
a multi-layer management orchestration functional component (MMO-FC) for management of SDN applications and services and inter-layer resource management.

2. The multi-layer management system according to claim 1, wherein the ERM-FC comprises:
an external management interworking support interface functional element for providing a management function for interworking with the external management entity;
a management information abstraction functional element for processing abstraction of management information of the SDN;
a request and reply interface functional element for providing a function of requesting a management operation to the external management entity and a function of replying to a request of the external management entity;
an external SDN policy management functional element for providing an external SDN policy to the external management entity; and
a multi-layer management orchestration support interface functional element for providing an internal interface to the MMO-FC.

3. The multi-layer management system according to claim 1, wherein the ALM-FC comprises:
an application layer (AL) support interface functional element for providing an interface with the SDN-AL;
an AL resource discovery functional element for performing discovery of the resources of the SDN-AL;
an AL resource monitoring and analytics functional element for collecting and analyzing statuses and events of the resources of the SDN-AL; and
an AL resource repository functional element for storing information on the resources discovered by the AL resource discovery functional element.

4. The multi-layer management system according to claim 3, wherein the ALM-FC further comprises:
an AL provisioning functional element for performing provisioning of a service of the SDN-AL;
an AL fault management functional element for performing fault management of the resources of the SDN-AL;
an AL performance management functional element for managing performance of the resources of the SDN-AL;
an AL security management functional element for performing security management of the resources of the SDN-AL;
an AL charging management functional element for performing charging management of the SDN-AL; and
an AL multi-layer orchestration support interface functional element for providing an internal interface to the MMO-FC,
wherein the AL fault management functional element, the AL performance management functional element, the AL security management functional element, and the AL charging management functional element perform respective functions based on an analysis result received from the AL resource monitoring and analytics functional element.

5. The multi-layer management system according to claim 4, wherein the AL provisioning functional element receives a service provisioning request from the SDN-AL, generates a provisioning policy, and provides the generated provisioning policy to the CLM-FC.

6. The multi-layer management system according to claim 1, wherein the RLM-FC comprises:
a resource layer (RL) support interface functional element for providing an interface with the SDN-RL;
a RL resource discovery and bootstrapping functional element for performing resource discovery and bootstrapping of the SDN-RL;
a RL resource repository functional element for storing information on resources discovered by the RL resource discovery and bootstrapping functional element;
a data and information abstraction functional element for performing abstraction of the information on resources received from the RL resource discovery and bootstrapping functional element; and
a virtual and physical resource correlation analysis functional element for analyzing a correlation between a virtual resource and a physical resource based on the information on resources received from the RL resource discovery and bootstrapping functional element.

7. The multi-layer management system according to claim 6, wherein the RLM-FC further comprises:
a resource layer (RL) resource monitoring and analytics functional element for analyzing resources of the SDN-RL;
a RL fault management functional element for performing fault management of the resources of the SDN-RL;
a RL performance management functional element for performing performance management of the resources of the SDN-RL;
a RL security management functional element for performing security management of the resources of the SDN-RL;
a RL charging management functional element for performing charging management of the resources of the SDN-RL; and
a RL multi-layer orchestration support interface functional element for providing an interface with the MMO-FC.

8. The multi-layer management system according to claim 7, wherein the RL resource monitoring and analytics functional element performs analysis on the resources based on the information on resources received from the RL resource discovery and bootstrapping functional element.

9. The multi-layer management system according to claim 8, wherein the RL fault management functional element, the RL performance management functional element, the RL security management functional element, and the RL charging management functional element perform respective functions based on an analysis result received from the RL resource monitoring and analytics functional element.

10. The multi-layer management system according to claim 1, wherein the CLM-FC comprises:
a control layer (CL) support interface functional element for providing an interface with the SDN-CL and the MMO-FC;
a CL resource discovery functional element for performing discovery of resources of the SDN-CL;
a CL resource repository functional element for storing information on the resources discovered by the CL resource discovery functional element;
a CL resource monitoring and analytics functional element for analyzing the resources of the SDN-CL; and
a CL configuration management functional element for generating resource configuration information based on a service provisioning request received from the SDN-AL.

11. The multi-layer management system according to claim 10, wherein the CLM-FC further comprises:
a control layer (CL) fault management functional element for fault management of the resources of the SDN-CL;
a CL performance management functional element for managing performance of the resources of the SDN-CL;
a CL security management functional element for security management of the resources of the SDN-CL;
a CL policy management functional element for managing a policy applied to a service of the SDN-CL; and
a multi-layer management orchestration support interface functional element providing an interface with the MMO-FC.

12. The multi-layer management system according to claim 11, wherein the CL fault management functional element, the CL performance management functional element, the CL security management functional element, and the CL policy management functional element perform respective functions based on an analysis result received from the CL resource monitoring and analytics functional element.

13. The multi-layer management system according to claim 1, wherein the MMO-FC comprises:
a multi-layer orchestration support interface functional element for providing interfaces with the ALM-FC, the CLM-FC, and the RLM-FC;
a RL management orchestration functional element for providing provisioning of resources of the SDN-RL and providing orchestration of configuration of the SDN-RL;
a multi-layer management function orchestration functional element for supporting management of SDN application and network services; and
an inter-layer service orchestration functional element for coordinating management operations between the SDN-AL, the SDN-RL, and the SDN-CL.
